(19) United States
(12) Patent Application Publication
(10) Pub. No.: US 2004/0188406 A1
(43) Pub. Date: Sep. 30, 2004

(54) Welding torch

(76) Inventor: Wilhelmus Antonius Johannes Brabander, Delft (NL)

Correspondence Address: Ryan A. Schneider, TROUTMAN SANDERS LLP, Bank of America Plaza, Suite 5200, 600 Peachtree Street, NE, Atlanta, GA, 30308-2216, US

(21) Appl. No.: 10/746,930

(22) Filed: Dec. 24, 2003

Related U.S. Application Data
(63) Continuation of application No. PCT/NL01/00488, filed on Jun. 28, 2001.

(30) Foreign Application Priority Data
Jul. 7, 2000 (NL) 1015649

(51) Int. Cl. B23K 9/173

(52) U.S. Cl. 219/137.61; 219/74

(57) ABSTRACT

A MIG torch includes a contact tube and an auxiliary electrode made from carbon, which is electrically connected to the contact tube. In a start phase, a primary welding arc is started between an MIG wire and a workpiece, with stationary wire. The primary arc melts a small portion of the MIG wire, but then reaches the auxiliary electrode, and keeps on burning there stationary, wherein the workpiece does melt but not the MIG wire. When a welding pool is sufficiently large, the wire feed is started.

### BENEFIT CLAIM

This application is a continuation of International Application No. PCT/NL01/00488, filed 28 Jun. 2001, which has priority to NL 1015649 filed 7 Jul. 2000.

### FIELD OF THE INVENTION

The present invention relates in general to the MIG welding process, and more particularly to a welding torch suitable for the MIG welding process.

### BACKGROUND OF THE INVENTION

Welding is a commonly known technique for connecting metal objects, wherein the metal objects are melted partially by means of an electric arc. Several welding processes have been developed within the general art of the welding technique, wherein the mutual differences reside in the manner in which the electric part is generated, the kind of electrode which is used, the kind of shielding gas which is used, and others.

A technique which is often used is welding with a consumable coated electrode. Herein, the electric arc is generated between the coated electrode and the workpiece, wherein both the workpiece and the electrode and the electrode coating melt. The melted electrode material, together with the melted workpiece material, forms a welding pool, which is shielded against influences from the surroundings by the melted coating material. After cooling down, said coating material (slag) is still to be removed. Although this technique per se is well applicable in certain areas, this technique knows some basic disadvantages. An example of such a disadvantage is the fact that the heat input into the welding pool is relatively large, such that the process is hardly or not applicable for processing thin plates. A further disadvantage is the fact that the consumable coated electrodes can only be used with relatively short lengths, wherein the individual electrodes must always be clamped in a current feed clamp; thus, it is difficult to carry out the welding process as a continuous process in the case of long welding seams.

In the case of another technique, indicated as MIG welding or MAG welding, use is also made of a consumable electrode, but now the electrode is fed as a continuous wire which is transported through a current feeding contact tube.

FIG. 6 illustrates schematically the known MIG welding process in general. A MIG wire 10 is fed from a supply roll 91 via a torch 4 towards a workpiece 1, by means of wire feeding means 90. A current source 20 is connected to the torch 4 and the workpiece 1. The torch 4 transfers the current to the MIG wire 10. An electric arc 3 burns between the end of the MIG wire 10 and the workpiece 1, whereby the MIG wire 10 melts and a welding pool 2 is formed on the workpiece 1.

FIG. 1 illustrates a standard MIG/MAG torch 100. This comprises a contact tube 101, usually made of copper, which is screwed onto a contact tube holder 102. The contact tube holder 102 has channels 103 for cooling water, and channels 104 for feeding a shielding gas 107. A gas cup 105 is mounted concentrically with the contact tube 101, which gas cup 105 is also made from copper but which is electrically isolated with respect to the contact tube holder 102 by means of an isolation sleeve 106. By means of wire feeding means which are not shown for the sake of simplicity, a welding wire 110 is transported through the contact tube holder 102 and the contact tube 101, the welding wire 110 making electrical contact with the contact tube 101. A current source 120 has its positive terminal connected to the contact tube holder 102, and has its negative terminal connected to a workpiece 1. An electric arc 130 is generated between the end of the welding wire 110 and the workpiece 1, wherein the end of the welding wire 110 melts and is added to the melted workpiece material. Herein, the melting of the wire is compensated by the feeding of new wire.

In this case, the welding pool 2 is shielded from influences from the surrounding by the shielding gas 107 flowing out of the gas cup 105. If the shielding gas comprises substantially inert components, such as argon, helium, etcetera, this technique is indicates as MIG welding (Metal Inert Gas). If the shielding gas comprises reactive components, such as 20% CO2, this technique is indicated as MAG welding (Metal Active Gas). Otherwise, as a process, MIG welding and MAG welding are basically identical to each other, except for the composition of the shielding gas 107.

Hereinafter, distinction will not be made and both processes will be indicated by the phrase MIG process.

The current source 120 is designed for providing a substantially constant, settable output voltage, i.e. this output voltage is substantially independent from the load within a large working area, wherein the magnitude of the current provided by the current source 120 depends on the load; such a characteristic is also indicated as a “horizontal characteristic”. The load is substantially determined by the Ohmic resistance of the welding torch 130, which is larger if the arc length is larger. This means that the magnitude of the current of the arc is smaller with larger arc length; the same applies to the power developed by the current, which in turn is a measure to the amount of wire which can be melted per unit time. Therefore, in the case of the MIG process, besides the arc voltage, the wire feeding speed is an adjusting parameter; in that case, a substantially constant arc current sets itself automatically. In the case of a larger wire feed speed, a smaller arc length with a larger arc current results. Depending from the nature of the workpiece to be welded, typical settings are approximately 20-25 V at approximately 125-150 A (thin sheet; short circuit arc welding) to approximately 40 V at approximately 400 A (quickly filling of seams in the case of heavy workpieces).

The MIG process is a welding process much used in industry. Once the process is going and has stabilized itself, very large weld lengths can be made continuously behind each other. Starting, however, is a problem with this process. As in the case of the earlier mentioned process with melting electrode, in the case of the MIG process the welding arc 130 is started by first effecting a short circuit between the free end of the welding wire 110 and the workpiece 1, causing a very large short circuit current. In short time, the spark generated herein grows to a welding arc, as result of which the welding wire 110 and the workpiece 1 will melt and a welding pool 2 will come into being. However, the workpiece 1 is cold at the beginning of the process, and it takes some time before the workpiece has melted sufficiently. This time will be longer as the workpiece conducts heat better: especially when the workpiece material is copper or aluminium, the time to the development of a sufficient welding pool can rise to multiple seconds.

The welding wire 110, however, is a relatively thin wire (typically in the range of about 0.9-1.6 mm thickness, wherein 1.2 mm is a much used diameter), and melts almost instantaneously when the welding arc arises. In fact, the starting of the process in this case is by starting the wire feeding unit; therefore, there is wire feed from the first beginning of the process, and this wire feed must be maintained in order to compensate the melting welding wire. Thus, in the starting phase, an amount of melted wire material is applied onto the workpiece without the workpiece itself being melted sufficiently. If the welding torch would now be displaced along the welding seam to be made, the first part of the welding seam comprises a binding error. Therefore, the welding torch can only be displaced when the temperature of the workpiece is sufficiently high, with the result that the first phase of the welding seam contains too much material which must be removed later; such a finishing process takes relatively much time, is labor-intensive, and is, therefore, expensive. As an alternative, use is made in practice of a starting piece, in which case the beginning of a weld is made on material which does not belong to the welding seam, or onto the final part of a previous welding seam, but even then material is deposited which must be removed later.

Hereinafter, the problems mentioned will be summarized by the phrase “cold start problem” of the conventional MIG process. This problem is a basic problem, which is caused by the fact that the arc which heats the workpiece during the start phase also heats and melts the welding wire.

In an attempt to solve these problems, a combined plasma/MIG system has already been developed, in which case elements of the MIG system are combined with elements of the plasma welding system.

Plasma welding is, briefly stated, based on generating an electric auxiliary arc or pilot arc between two electrodes. In a practical application, a plasma torch 200, illustrated schematically in FIG. 2, comprises a water-cooled copper tube 201 which functions as one electrode, and a tungsten rod 202 arranged concentrically therein, which functions as other electrode, said tungsten rod electrode 202 being electrically isolated with respect to the copper tube electrode 201. A pilot current source 220 has its positive terminal connected to the copper tube electrode 201, and has its negative terminal connected to an electrode holder for the tungsten rod electrode 202, which is not shown in FIG. 2 for the sake of simplicity. A pilot gas, usually 100% Ar, is fed in an annular channel 203 between the tungsten rod 202 and the copper tube electrode 201. A pilot arc 230 is generated between the end of the tungsten rod electrode 202 and the end of the copper tube electrode 201. By the speed of the flowing pilot gas, the generated plasma is, as it were, blown outwards at the open end of the copper tube electrode 201.

A main current source 240 has its negative terminal connected to the tungsten rod electrode 202 and has its positive terminal connected to a workpiece 1. A main arc between the tungsten electrode 202 and the workpiece 1, fed by the main current source 240, is started by the pilot arc 230. A shielding gas, usually a mixture of Ar and H₂, is fed in an annular channel 204 between the copper tube electrode 201 and a ceramic gas cup 205.

The tungsten electrode is non-consumable. Possible additional material (welding wire) must be supplied externally.

In the development of a plasma/MIG system, an important aspect of the plasma system has been projected onto the MIG system in adapted form; this aspect concerns the presence of two current sources, wherein a main current source is switched between electrode and workpiece, and wherein an auxiliary current source is connected with an auxiliary electrode within the torch.

In the case of plasma/MIG welding, a welding torch 300, illustrated schematically in FIG. 3, comprises a contact tube 301 through which a consumable welding wire (MIG wire) 310 is supplied. A tubular plasma electrode 303, electrically isolated with respect to the contact tube 301, is arranged around said contact tube 301, the plasma electrode 303 having its end extending beyond the end of the contact tube 301 and being provided with a carbon ring 304. Gas to be ionized, indicated as plasma gas, is supplied in a first annular space 302, formed between the contact tube 301 and the tubular plasma electrode 303. Shielding gas is supplied in a second annular space 305, formed between the tubular plasma electrode 303 and a gas cup 308.

Use is made of two current sources. A first current source 320, indicated as plasma current source, has its positive terminal connected to the tubular plasma electrode 303, and has its negative terminal connected to a workpiece 1. A second current source 340, indicated as MIG current source, has its positive terminal connected to the contact tube 301, and has its negative terminal connected to the workpiece 1. The MIG current source 340 must be a current source with switchable characteristic: in a first operative condition, the MIG current source 340 has a vertical characteristic, and in a second operative condition the MIG current source 340 has a horizontal characteristic.

Starting this system is a complicated procedure. Both current sources 320, 340 are activated, the MIG current source 340 being switched in its vertical characteristic, which means that the MIG current source 340 provides a substantially constant current intensity, wherein the clamp voltage of the source adapts itself to the load. Herein, the current intensity to be supplied by the MIG current source 340 is set to a value in the order of 5 A. The MIG wire 310 is transported forwards relatively slowly by means of a wire feed unit, such that the MIG wire 310 will leave the contact tube 301 and, at a certain moment, will make contact with the workpiece1. Caused by this short circuit, the MIG current source 340 starts to supply current, which is detected, whereupon the direction of transport of the wire supply unit is inverted and the MIG wire 310 is pulled back. Hereby, the short circuit is cancelled and an arc 330 comes into being, indicated as MIG start arc, of which the length grows by the MIG wire 310 pulling back, causing also the arc voltage to rise. Also the current intensity can now be raised in a controlled manner. However, the current intensity is relatively small, such that little or no melting of the MIG wire 310 occurs.

When the end of the withdrawing MIG wire 310 passes the free end of the tubular plasma electrode 303, and the upper end of the MIG starting arc 330 generated between the MIG wire 310 and the workpiece 1 thus reaches the free end of the tubular plasma electrode 303, the gas in the space between the free end of the tubular plasma electrode 303 and the workpiece 1 will be ionized sufficiently by the MIG starting arc 330, such that a conductive path is formed between the free end of the tubular plasma electrode 303 and the workpiece 1. Caused by this, a second electric arc 332 will be ignited between the free end of the tubular plasma electrode 303 and the workpiece 1, fed by the plasma current source 320 and indicated as plasma arc. Ignition of the plasma arc 332 is detected, upon which the wire feed unit is stopped and the MIG current source 340 is switched off. Now, only the plasma arc 332 burns, with a pre-set current intensity which is substantially higher than the current intensity of the starting arc 330 generated between the MIG wire 310 and the workpiece 1 by the MIG current source 340 in the starting phase. Said pre-set current intensity will usually lie in the range of 50-250 A, depending on the material and the thickness of the workpiece. The workpiece 1 is heated and brought to melting by this plasma arc 332. The time needed for this depends on the kind of material and the thickness thereof. However, an important aspect herein is that the MIG wire 310 does not melt in this time, such that the disadvantages of the MIG process mentioned above are avoided.

When the weld pool is sufficiently large, the MIG current source 340 is switched on again, now in its horizontal characteristic, and the wire feed unit is switched on again in order to transport the MIG wire 310 forwards. At a certain moment, the end of the MIG wire 310 reaches the plasma arc 332, as result of which an arc fed by the MIG current source 340 will ignite between the end of the MIG wire 310 and the workpiece 1, indicated as MIG arc 330; depending on the desired welding speed, the current intensity of the MIG arc can be as high as 500 A. In this case, no short circuiting takes place between the MIG wire 310 and the workpiece 1. Subsequently, the proper welding process can begin, wherein both the MIG arc 333 and the plasma arc 332 keep on burning and therefore both current sources stay active.

Although the plasma MIG process per se functions well and the disadvantages of the MIG process can be avoided by this, because the proper welding process begins with a hot start, important disadvantages are connected with this, too.

In the first place, a complicated, large, heavy and expensive welding torch is necessary.

Because of the use of a plasma arc, the torch must be provided with water cooling.

Further, two valuable current sources are needed, which both must be operative continuously.

Further, separate gas provisions are necessary for the plasma arc and the shielding gas.

Further, a computer control must be provided which executes the above-described procedure.

All this makes the required apparatus very expensive.

### SUMMARY OF THE INVENTION

It is a general objective of the present invention to eliminate or at least reduce the problems mentioned. More particularly, the present invention aims to provide welding apparatus which can be manufactured in a relatively simple and relatively cheep manner, and with which a hot start for the MIG process can be performed.

According to the present invention, these objectives can be accomplished by means of a minor adaptation of a standard MIG torch, as well as minor adaptations to a standard MIG current source. The present invention is based on the insight that, for generating a plasma current between a plasma electrode and a workpiece, functioning as auxiliary arc or preheating arc, it is not necessary that this plasma electrode is electrically isolated with respect to the contact tube for the MIG wire. Thus, the present invention provides a welding torch with a contact tube and also a plasma electrode arranged in the vicinity of the contact tube and electrically connected therewith, at least the end of this plasma electrode being made of an arc-resistant material such as carbon or graphite; otherwise, this torch can be identical to a standard MIG torch. Further, the present invention provides a current source system comprising a first current source for large power and a second current source coupled in parallel therewith for relatively small power (for instance around 100 V/150 mA). Preferably, a high voltage supply is coupled in parallel with the first current source (for instance about 12 kV/2 mA). The first current source can be identical to a standard MIG current source.

These two current sources can be implemented practically as a single apparatus with a single output, such that only one single current supply cable to the torch is needed.

With the described plasma/MIG system, a sophisticated computer control is needed; such sophisticated computer control is not necessary with the torch proposed by the present invention.

With the described plasma/MIG system, a water cooling is always necessary. With the torch proposed by the present invention, water cooling is not necessary in a large range of current intensity; only with very large current intensity (250 A and more), water cooling can appear to be necessary. In hand-welding, such large current intensities are usually not used, and hence no water cooling is necessary. Furthermore, in hand-welding no auxiliary supplies are necessary. Therefore, a torch intended for hand-welding can be small, light-weight and cheap.

### BRIEF DESCRIPTION OF THE DRAWINGS

These and other aspects, characteristics and advantages of the present invention will be explained in more detail by the following description of a preferred embodiment of a welding torch according to the invention, with reference to the drawing, in which same reference numerals indicate same or similar parts, and in which:

FIG. 1 illustrates schematically a standard MIG torch;

FIG. 2 illustrates schematically a standard plasma torch;

FIG. 3 illustrates schematically a standard plasma/MIG torch;

FIGS. 4A-C illustrate schematically electrical circuits;

FIG. 5 illustrates schematically an embodiment of a torch proposed by the present invention; and

and FIG. 6 illustrates schematically the MIG welding process.

### DETAILED DESCRIPTION OF THE INVENTION

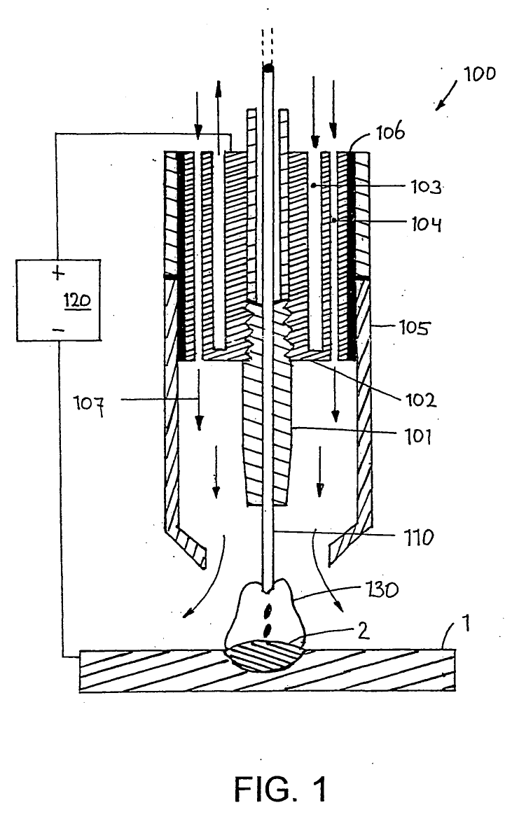

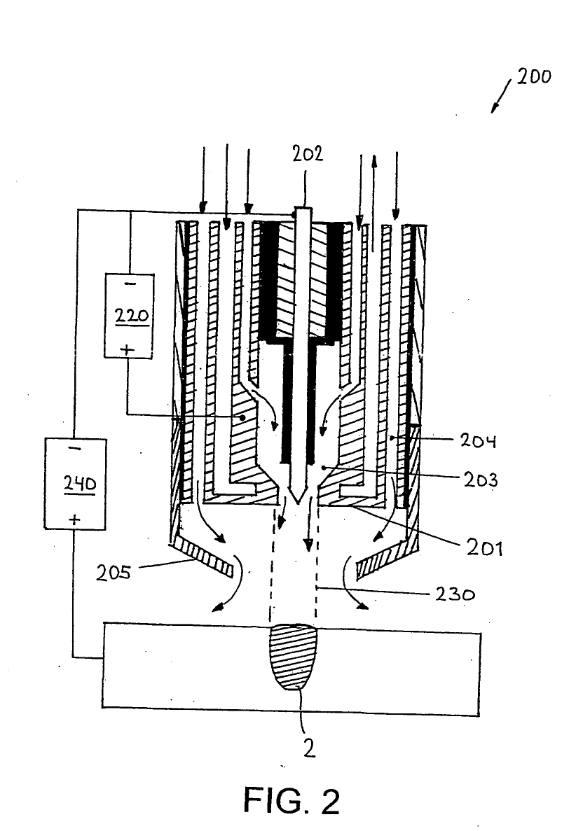

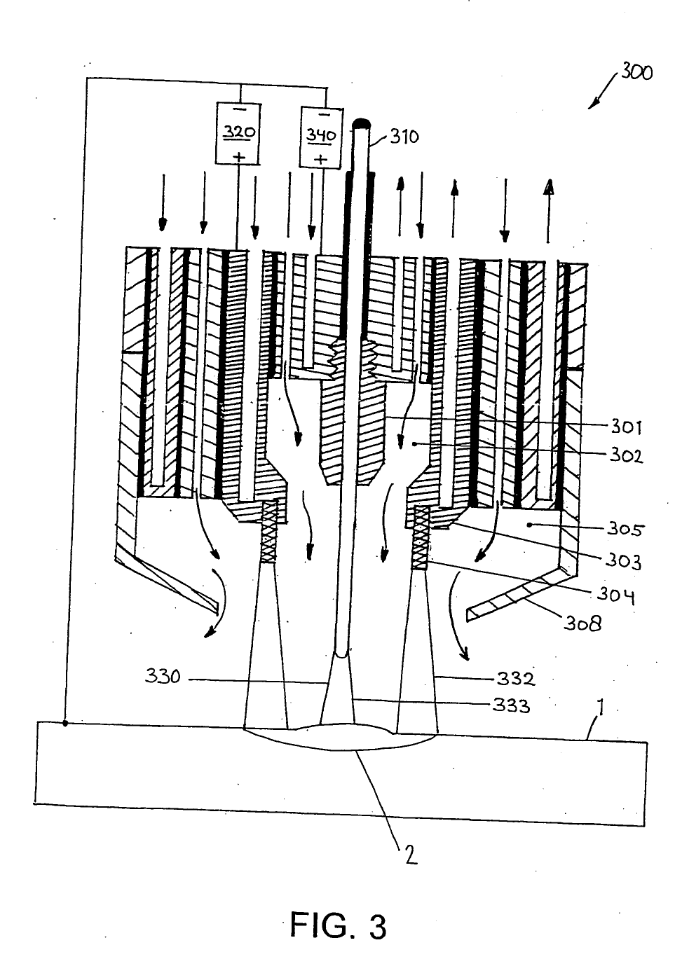

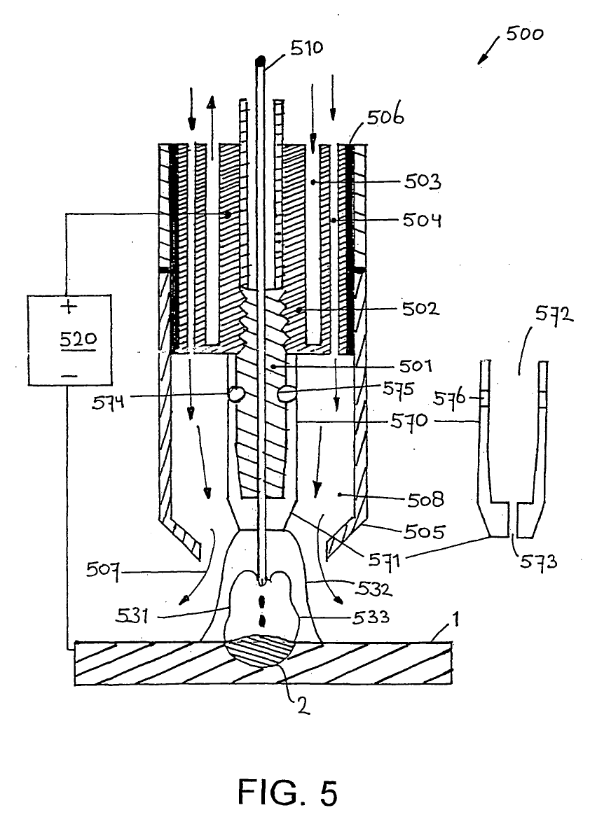

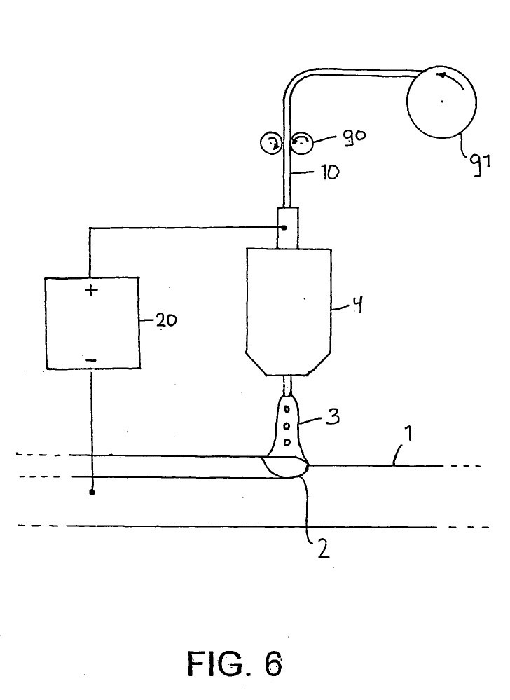

FIG. 5 illustrates schematically an embodiment of a welding torch 500 according to the present invention. Although a welding torch according to the present invention could be developed completely in new, according to an important aspect of the present invention it is possible to manufacture a welding torch according to the present invention by a minor adaptation of a standard MIG torch. The embodiment shown in FIG. 5 is based on a standard MIG torch 100 such as illustrated in FIG. 1; those parts which are identical to parts of the standard MIG torch 100 illustrated in FIG. 1 are indicated in FIG. 5 with the same reference numeral, raised by 400. For an elaborate description of these parts, reference is made to the description of FIG. 1.

The welding torch 500 according to the present invention comprises a contact tube 501, which is mounted on a contact tube holder 502. The contact tube 501 should on the one hand guide a MIG wire 510 towards the desired place, and should on the other hand transfer the welding current to the MIG wire 510. To this end, the contact tube 501 is made of an electrically conductive material, and has a bore of which the diameter is substantially equal to the diameter of the MIG wire 510 used. The surface of this bore must be resistant against the friction context with the MIG wire 510. Standard contact tubes are made of copper, and are screwed into the contact tube holder, but it will be clear that the invention is not restricted to such constructive details. The contact tube holder 502 is provided with cooling channels 503 for cooling water or cooling air. For the supply of shielding gas 507, the contact tube holder 502 is provided with gas channels 504.

A gas cup 505 is connected to the contact tube holder 502, and surrounds the contact tube 501, the gas cup 505 reaching further than the contact tube 501 as seen from the contact tube holder 502. Standard gas cups for MIG torches are manufactured from copper and are electrically isolated with respect to the contact tube holder 502 by means of an isolation sleeve 506, but it will be clear that the invention is not restricted to such constructive details. The interior of the gas cup 505 forms a gas space 508, into which the gas channels 504 end.

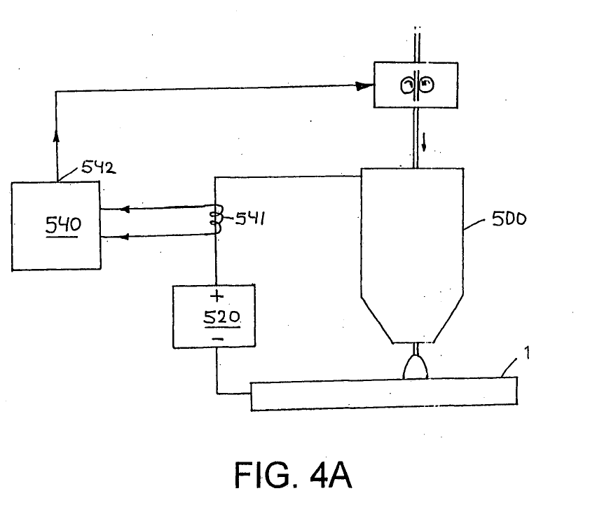

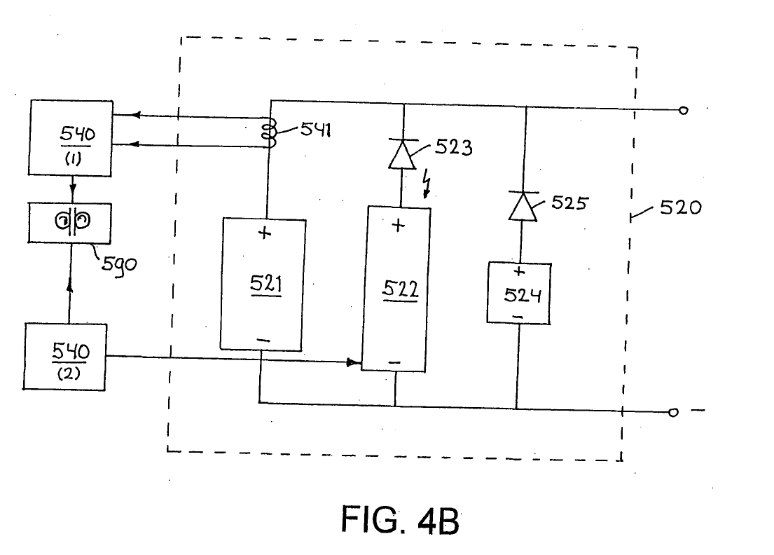

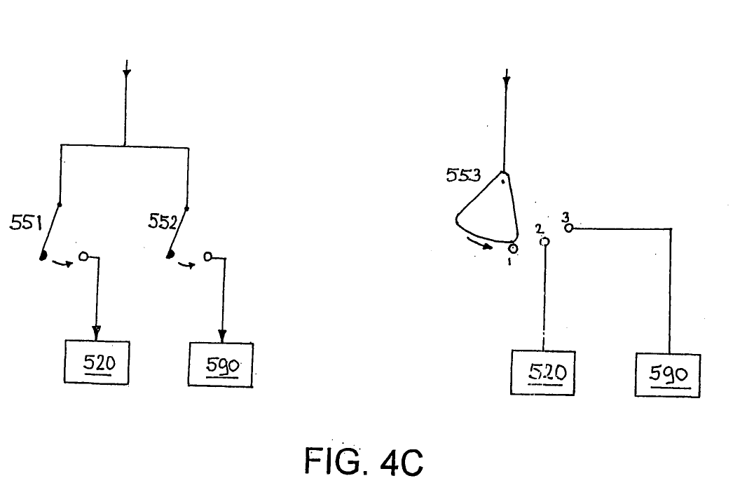

The torch 500 according to the present invention can do with one single current connection. In FIG. 5, a current source 520 is shown schematically, having its positive terminal connected to the contact tube holder 502, and having its negative terminal connected to a workpiece 1. Details of this current source 520 will later be described in more detail with reference to FIG. 4.

According to an important aspect of the present invention, the torch 500 comprises an auxiliary electrode 570 which is electrically connected to the contact tube holder 502 and/or the contact tube 501.

In the embodiment shown, the auxiliary electrode 570 is connected to the contact tube 501. As an alternative, the auxiliary electrode 570 could be connected to the contact tube holder 502. If desired, the auxiliary electrode 570 could be mounted in any manner; important is only that there exists an electrical connection between the contact tube holder 502 and the auxiliary electrode 570.

The auxiliary electrode 570 has a free end 571 which is beyond the free end of the contact tube 501. The distance between the free end 571 of the auxiliary electrode 570 and a MIG wire 510 projecting from the contact tube 501 preferably is as small as possible. In the embodiment shown, the auxiliary electrode 570 is implemented as a hollow rod, which at its upper end is provided with a contact tube receiving chamber 572 of which the contour fits to the contour of the contact tube 501, and which at its lower end 571 is provided with a bore 573 for passing the MIG wire 510. In principle, this bore 573 could have a diameter slightly larger than the diameter of the MIG wire 510, but preferably the diameter of this bore 573 is equal to the diameter of the bore of the contact tube 501. Thus, the auxiliary electrode 570 completely surrounds the contact tube 501, and the auxiliary electrode 570 surrounds a portion of the MIG wire projecting from the contact tube 501.

Preferably, the lower end 570 of the auxiliary electrode 570 is tapered, as shown, in order to disturb the gas flow 507 as little as possible.

In the embodiment illustrated in FIG. 5, the auxiliary electrode 570 is secured to the contact tube 571 by means of a U-shaped or Ω-shaped clamp bracket or clamp spring 574. To that end, the contact tube 501 is provided with a circumferential groove 575, and the auxiliary electrode 570 is provided with at least one but preferably two windows 576 opposite each other, of which the position corresponds to the position of the circumferential groove 575 of the contact tube 501. The clamp member 574 has two clamp leg portions which, in the assembled condition, partly lie in the circumferential groove 575 of the contact tube 501 and partly lie in the windows 576 of the auxiliary electrode 570. The clamp member 574 can be applied and removed with a sliding movement in a direction perpendicular to the centre line of the contact tube 501. Thus, mounting or removing the auxiliary electrode 570 is an extremely simple action.

Preferably, the clamping member 574 is manufactured from an electrically conductive material.

However, it is not essential that the auxiliary electrode 570 is implemented as a hollow rod completely surrounding the contact tube 501. By way of alternative, it is well possible that the auxiliary electrode 570 is implemented as one or multiple electrode rods which is/are clamped to the side of the contact tube 501, parallel thereto.

The auxiliary electrode 570 is made of an arc resistive material, i.e. a material which will not melt on contact with an welding arc. Carbon or graphite is a material which has proven to be particularly suitable.

Now, the operation of the torch 500 proposed by the present invention will be explained in a situation of welding by hand. Before the welding process is started, it is assured that the MIG wire 510 projects from the gas cup 505; under normal circumstances this will already be the case after ending a previous welding cycle, but if desired the initial position of the MIG wire can be adapted by means of the wire feed means (which are not shown in FIG. 5 for the sake of simplicity; see 90 FIG. 6).

With the welding source 520 switched on but wire feed means switched off, a short circuit is now caused by bringing the end of the MIG wire 510 in contact to the workpiece 1. Hereby, a primary MIG arc 531 will be started between the end of the MIG wire 510 and the workpiece 1. By heating by the hot arc 531, the MIG wire 510 will melt away. Because the wire feed means are switched off, the end of the MIG wire 510 moves away from the workpiece 1 in the direction of the contact tube 501.

When the end of the MIG wire 510 reaches the end 571 of the auxiliary electrode 570, and the upper end of the primary MIG arc 531 makes contact to the end 571 of the auxiliary electrode 570, the welding arc will burn completely between the auxiliary electrode 570 and the workpiece 1, and the MIG wire 510 will no longer melt. The arc now burning between the auxiliary electrode 570 and the workpiece 1 will be indicated as preheat arc 532. This preheat arc 532 is a stable arc, of which the current magnitude is determined by the distance between the end 571 of the auxiliary electrode 570 and the workpiece 1. The preheat arc 532 does heat the workpiece 1 and a welding pool 2 is formed, but no material of the MIG wire 510 melts away. Thus, the above-discussed disadvantages of the standard MIG process are avoided.

This situation, indicated as preheat period, is continued until the workpiece 1 has been heated sufficiently and/or the welding pool 2 is sufficiently large. The precise duration of this preheat period, inter alia, depends on the workpiece material, the thickness thereof, and other characteristics.

Then, the actual welding process is started by starting the wire feed means, such that the MIG wire 510 leaves the contact tube 501 with the desired speed. Now, the arc leaves the auxiliary electrode 570 and burns between the end of the MIG wire 510 and the workpiece 1; in this stage, the arc will be indicated as secondary MIG arc 533. In the further course of the welding process, the torch 500 behaves as a standard MIG torch; therefore, the further course of the welding process does not need to be discussed in more detail.

In the preferred exemplary embodiment discussed, a separate auxiliary electrode 570 is arranged next to a contact tube 501, which contact tube 501 can be a standard contact tube. As discussed, the auxiliary electrode 570 can extend around the contact tube 501, and can be fixed thereto. However, both aspects are not necessary. As will be clear from the above description, the auxiliary electrode 570 serves as a non-melting contact point for the welding arc during the preheat phase, wherein it is important that on the one hand a welding arc with relatively large power burns in order to effect a high heat input into the workpiece, while on the other hand this arc is not in contact with the MIG wire in order to avoid melting of the MIG wire in this stage. A standard contact tube made from copper would not be suitable for this purpose. However, when at least the end of the contact tube itself is made arc-resistive, a separate auxiliary electrode is not necessary.

The end of the contact tube could be made arc-resistive in several ways. In the first place, an arc-resistive contact tube point could be fixed to a contact tube which is otherwise implemented in a standard manner; in fact, this is the embodiment discussed with reference to FIG. 5. In the second place, the end of the contact tube could be provided with an arc-resistive protective layer, which then forms an integral part of the contact tube. A disadvantage of the second possibility is, inter alia, that then no use can be made of standard contact tubes, such that the implementation becomes more expensive.

The method described above is very useful when the welding is executed by hand. The torch 500 can be provided with a hand-controlled switch for starting the wire feed means. The welder starts the process by bringing the MIG wire 510 into contact with the workpiece, visually monitors the melting workpiece, and starts the wire feed when he/she is satisfied with the welding pool developed. However, starting of the wire feed means can also take place automatically by a control unit 540, a fixed, preset time after starting the primary MIG arc 531. FIG. 4A shows schematically such control unit 540, which is connected to a current detector 541 which detects whether the current source 520 delivers current, and of which a control output 542 controls the wire feed means 590. For example, the control unit 540 can actuate a relay, which replaces the said manual switch for the wire feed means 590.

Instead of starting by means of short circuiting, it is also possible to start with a high voltage pulse. Such a starting method is useful in hand welding, but is also perfectly suitable for application in automatic welding apparatus, welding robots, and others.

FIG. 4B shows schematically a circuit which allows this way of starting. A first current source 521 can be a standard, unamended MIG arc source with a horizontal characteristic. It is noted that this first or main current source 521 does not need to have a switchable characteristic. Parallel thereto an auxiliary voltage source 522 is connected, which auxiliary voltage source 522 is arranged for providing high voltage pulses with sufficiently high voltage, for instance 12 kV, wherein a small current magnitude is sufficient, for instance 2 μA. In order to prevent that the first current source 521 influences this auxiliary voltage source 522, preferably, and as shown, a member which conducts only in one direction, such as a diode 523, is connected in series with the auxiliary voltage source 522.

For starting the welding process, the first current source 521 is switched on, with the wire feed means 590 switched off. Because no short circuiting is made, the first current source 521 can not provide current. Then, the auxiliary voltage source 522 is switched on. The auxiliary voltage source 522 and the first current source 521 can also be switched on simultaneously. As a consequence of a high voltage pulse, a breakdown takes place between MIG wire 510 and workpiece 1, which breakdown defines a conductive path. Now, the first current source 521 can provide current, which current makes the original breakdown or spark grow to the primary MIG arc 531. The voltage necessary for causing said breakdown depends on the breakdown voltage of the used gas (for argon this is approximately 250 V/mm) and on the working distance, i.e. the distance between the end of the contact tube and the workpiece, which in practice will be in the order of 10 mm. Therefore, the auxiliary voltage source 522 preferably can provide at least 2500 V, but preferably there is an adequate reserve, for which reason use is preferably made of an auxiliary voltage source capable of providing at least 5 kV or rather even at least 10 kV. The required current magnitude is minimal: some micro-amperes suffices. Such voltage sources are available as standard, for which reason the design of the auxiliary voltage source 522 will not be described in more detail; suffice it to say that the required power is relatively small, that the dimensions are relatively small, and that the costs are relatively small.

In this situation, too, starting of the wire supply means 590 can take place under control of a control unit 540. The control unit 540, indicated in FIG. 4B at (1), can be provided with a current detector 541 which delivers a detection signal when the first current source 521 delivers current; after receiving that signal, the control unit 540 waits a predetermined time, and then starts the wire supply means 590. As an alternative, it is possible that the control unit 540, indicated in FIG. 4B at (2), first triggers the auxiliary voltage source 522, then waits a predetermined time, and then starts the wire feed means 590; in that case, no current detector 541 is necessary.

Use can be made of the control unit 540 when stopping the welding process, too. In the first-mentioned case (1), the control unit 540 can be arranged for switching off the wire feed means 590 when the signal of the current detector 541 falls away, signalling that the first current source 521 does not provide current anymore. In the second case (2) the control unit 540 can be arranged for switching off the wire feed means 590 and the current source 520, at least the main current source 521, simultaneously, whenever it is desired to stop.

A further starting aid can be offered by an auxiliary current source (with vertical characteristic) 524 which, as is the auxiliary voltage source 522, is connected in parallel to the main current source 521. Also in this case, preferably, and as shown, a diode 525 or the like is connected in series with the auxiliary current source 524. The auxiliary current source 524 can be a small and relatively cheap source, which is arranged for example for providing a small current of about 150 mA at a voltage in the order of about 100 V. The current magnitude to be provided by the auxiliary current source 524 thus is much smaller than the current magnitude to be provided by the main current source 521.

As discussed, the main current source 521 (standard MIG current source) has a horizontal characteristic, wherein the arc voltage desired for the welding process is set. In situations where there is a relatively large distance between the end of the welding wire and the workpiece on starting, and wherein starting is thus executed by a high voltage pulse, the arc voltage set can be insufficient for letting the spark caused by the high voltage pulse grow to an arc discharge, because the ionization channel of this spark still has a relatively high resistance. This problem is overcome by the auxiliary current source 524: for this auxiliary current source 524, said ionization channel suffices as it were, and the auxiliary current source 524 is capable to increase the current magnitude in said ionization channel, causing the width of the ionization channel to increase and the resistance thereof to decrease, such that the arc voltage decreases to the set voltage of the main source. Eventually, the actual current magnitude of the arc will be provided by the main current source 521.

Although the above explanation of the events on starting up is relatively long, said events in fact go super-fast. Therefore, the auxiliary current source 524 does not need to be a continuous current source; it suffices if the auxiliary current source 524 is capable to provide a current pulse with the above-mentioned values.

In a standard MIG torch, the standard contact tube is made from copper. In MIG welding, metal splashes will emerge, a part of which will attach to the surface of the contact tube. As a consequence, a disturbance of the flow of the shielding gas occurs, and it is regularly necessary to clean the contact tube. When the contact tube is provided with a carbon or graphite mantle, as proposed by the present invention, metal splashes will attach not or hardly on the outer surface of that mantle.

In the standard MIG-welding process, the equipment is provided with a single control switch, with which the current source and the wire feed means can be switched on or off simultaneously. When that switch is switched over to the ON position, the arc ignites when the wire touches the workpiece. In hand welding, a control switch with automatic return to the OFF position is incorporated in the torch: as long as the welder keeps depressed the control switch, the wire feed means keep feeding wire. In automatic welding, the welding equipment can be provided with a switch having two positions.

Stopping of the wire feed can occur deliberately, by the welder letting go of the control switch, or by an operator setting back the two-position switch of the welding equipment to an OFF position; the arc stops, too, because then the current source is switched off, too. Stopping of the wire feed can also occur unintentionally, for instance because the wire gets stuck in the torch for any reason. Because the current source remains switched on, the arc keeps thus burning at a stationary wire. The part of the wire projecting out of the contact tube melts away very quickly, and the arc makes contact with the copper contact tube, which is eroded thereby. This means wear/damage of the contact tube, which, therefore needs to be replaced after some time.

In hand welding, this is counteracted because the welder in reaction on the getting stuck, lets go of the control switch, whereby the current source switches off. In automatic welding, the operator will have to switch off the current source with a quick reaction, too.

The above-mentioned problems are eliminated or at least reduced when the torch is implemented in the manner as proposed by the present invention, i.e. with an arc resistive contact tube or with an arc resistive auxiliary electrode. When the wire feed stops in this case, the welding arc will melt away the part of the welding wire projecting out of the contact tube, indeed, and thus will come into contact with the arc resistive contact tube or with the arc resistive auxiliary electrode, just as described in relation to the starting process. In this case, the arc does not cause any damage to the contact tube. If the welding wire gets stuck unexpectedly, the operator has more time to intervene without the contact tube getting damaged.

For actuating the welding equipment, the welding torch proposed by the present invention is preferably equipped with two switches 551,552, or with a single three-position switch 553, indicated schematically left and right, respectively, in FIG. 4C. Hereby, it is possible to actuate the current source 520 and the wire feed means 590 independently of each other. In rest, both switches 551, 550 are OFF, or the three-position switch 553 is in position ONE, respectively. For turning on the current source 520, the welder puts the one switch 551 into the position ON, or the welder puts the three-position switch 553 into position TWO, respectively; now the arc can be started without wire feed. For starting the wire feed means 590, the welder then also puts the second switch 552 into the position ON, or the welder puts the three-position switch 553 into position THREE, respectively; now there is welding. In order to end the process, the welder lets go of both switches 551, 552 or the three-position switch 553, respectively: those switches/this switch return(s) back to the OFF position automatically.

It will be clear for a person skilled in the art that the scope of the present invention is not limited to the examples discussed above, but that several amendments and modifications thereof are possible without departing from the scope of the invention as defined in the attached claims. For instance, it is possible that the combination of first current source 521 and auxiliary supplies, and even including the control unit, is built together as an integrated apparatus. However, it is also possible that the combination of auxiliary voltage source 522 and auxiliary current source 524 is provided as an auxiliary unit to be connected to the output of a standard MIG welding source.

It is also possible that the contact tube 501 and the contact tube holder 502 are manufactured as a single integrated unit. However, the use of loose contact tubes is preferred, because then they can be replaced more easily.

What is claimed is:

1. MIG welding torch with arc resistive contact tube.

2. MIG welding torch with contact tube and arc resistive auxiliary electrode which is electrically connected to the contact tube.

3. Contact tube for a welding torch, of which at least the free end is made arc-resistive.

4. Contact tube according to claim 3, wherein at least the free end is provided with an arc-resistive cover, preferably made from carbon or graphite.

5. Contact tube according to claim 3, wherein a tubular protective cap is arranged around the free end of the contact tube, electrically connected to the contact tube, said tubular protective cap being made from an electrically conducting and arc-resistive material, for instance carbon or graphite.

6. Contact tube according to claim 5, wherein the tubular protective cap is implemented as a hollow rod, the upper end of which is provided with a contact tube receiving chamber of which the contour fits to the contour of the contact tube, and of which the lower end is provided with a bore for passing a MIG wire, said bore having a diameter which preferably is equal to or only slightly larger than the diameter of a corresponding bore of the contact tube.

7. Contact tube according to claim 6, provided with a circumferential groove;
wherein the tubular protective cap is provided with at least one but preferably two opposite windows of which the position corresponds to the position of such circumferential groove;
and wherein the tubular protective cap is fixed to the contact tube by means of a clamp member with for instance a U-shaped or Ω-shaped contour or the like, of which a clamp leg portion partly lies in said circumferential groove and partial lies in said window.

8. Welding torch, comprising:
a contact tube holder;
a contact tube according to claim 3, fixed to contact tube holder for guiding therethrough a MIG wire and for transferring welding current to the MIG wire.

9. Welding torch, comprising:
a contact tube holder;
a contact tube fixed to contact tube holder for guiding therethrough a MIG wire and for transferring welding current to the MIG wire;
and at least one auxiliary electrode arranged in the vicinity of the contact tube and electrically connected to the contact tube.

10. Welding torch according to claim 9, wherein the auxiliary electrode is connected mechanically and electrically to the contact tube holder.

11. Welding torch according to claim 9, wherein the auxiliary electrode is connected mechanically and electrically to the contact tube.

12. Welding torch according to claim 9, wherein at least the free end of the auxiliary electrode is made from an electrically conducting and arc-resistive material, preferably carbon or graphite.

13. Welding torch according to claim 9, wherein the free end of the auxiliary electrode, as seen from the contact tube holder, is located beyond the free end of the contact tube.

14. Welding torch according to claim 9, wherein the auxiliary electrode stretches around the contact tube.

15. Welding torch according to claim 9, wherein the auxiliary electrode is implemented as a hollow rod, the upper end of which is provided with a contact tube receiving chamber of which the contour fits to the contour of the contact tube, and of which the lower end is provided with a bore for passing a MIG wire, said bore having a diameter which preferably is equal to or only slightly larger than the diameter of a corresponding bore of the contact tube.

16. Welding torch according to claim 15,
wherein the auxiliary electrode is connected mechanically and electrically to the contact tube;
wherein the contact tube is provided with a circumferential groove;
wherein the auxiliary electrode is provided with at least one but preferably two opposite windows of which the position corresponds to the position of such circumferential groove;
and wherein the auxiliary electrode is fixed to the contact tube by means of a clamp member with for instance a U-shaped or Ω-shaped contour or the like, of which a clamp leg portion partly lies in said circumferential groove and partial lies in said window.

17. Welding torch according to claim 1, provided with two control switches or a three-position control switch.

18. Welding method using a welding torch according to claim 1, comprising the steps of:
(a) starting a primary MIG arc between a MIG wire and a workpiece;
(b) letting the primary MIG arc grow until it touches the arc-resistive contact tube or the arc-resistive auxiliary electrode, respectively;
(c) during some time, letting a preheat arc burn between the workpiece and the arc-resistive contact tube or the arc-resistive auxiliary electrode, respectively, in order to thus preheat the workpiece and generate a welding pool without the MIG wire substantially melting away; and
(d) when the workpiece has been heated sufficiently or the welding pool is sufficiently large, respectively, starting wire feed means in order to feed the MIG wire, such that a secondary MIG arc burns between the fed MIG wire and the workpiece, wherein the MIG wire melts away.

19. Method according to claim 18, wherein in step (a) the primary MIG arc is started by bringing the free end of MIG wire into contact with workpiece.

20. Method according to claim 18, wherein in step (a) the primary MIG arc is started by applying a high voltage pulse between MIG wire and workpiece.

21. Method according to claim 18, wherein during steps (a), (b) and (c) the wire feed means are switched off.

22. Method according to claim 18, wherein during step (c) the preheat arc is maintained during a predetermined time, and wherein step (d) is started automatically on expiration of said predetermined time.

23. Method according to claim 18, wherein said steps are performed under control by a control unit.

24. Method according to claim 18, wherein during step (c) the preheat arc is maintained until a welder optically observes that the welding pool is sufficiently large, after which said welder starts step (d) by hand.

25. Current source system for use with a welding torch according to claim 1, comprising:
a first current source, suitable for feeding a MIG arc;
and a series arrangement of a high voltage source and a diode, connected in parallel to the first current source.

26. Current source system according to claim 25, wherein the high voltage source is arranged for providing high voltage pulses with an amplitude of at least 2500 V, preferably at least 5000 V, and more preferably at least 10000 V.

27. Current source system according to claim 25, further comprising a series arrangement of an auxiliary current source and a diode, connected in parallel to the first current source.

28. Current source system according to claim 27, wherein the auxiliary current source is arranged for providing a current of at least about 50 mA and typically about 150 mA at a voltage of at least about 50 V and typically about 100 V.

29. Auxiliary unit, arranged for connection to the output of a main current source, comprising a first series arrangement of a high voltage source and a diode, and a second series arrangement of an auxiliary current source and a diode connected in parallel to said first series arrangement.

30. Auxiliary unit according to claim 29, wherein the high voltage source is arranged for providing high voltage pulses with an amplitude of at least 2500 V, preferably at least 5000 V, and more preferably at least 10000 V; and
wherein the auxiliary current source is arranged for providing a current of at least about 50 mA and typically about 150 mA at a voltage of at least about 50 V and typically about 100 V.

31. Welding apparatus, comprising:
a current source system according to claim 25, or a MIG current source and a auxiliary unit according to claim 29 coupled in parallel therewith;
a welding torch according to claim 17; and
wire feed means for feeding a MIG wire towards the welding torch;
wherein one of the control switches of the welding torch or one of the positions of the three-positions control switch, respectively, actuates the current source system or the MIG current source, respectively, and wherein the other of the control switches of the welding torch or the other of the positions of the three-position control switch, respectively, controls the wire feed means.

32. Welding apparatus, comprising:
a current source system according to claim 25, or a MIG current source and an auxiliary unit according to claim 29 coupled in parallel therewith;
a welding torch according to claim 1;
wire feed means for feeding a MIG wire towards the welding torch;
and a control unit which controls the switching on/off of the current source system or the MIG current source, respectively, and the wire feed means;
wherein the control unit is arranged to:
first switching on the current source system or the MIG current source, respectively;
switch on the wire feed means a pre-set time later;
and to switch off the wire feed means and the current source system or the MIG current source, respectively, substantially simultaneously.
